(19) United States
(12) Patent Application Publication
(10) Pub. No.: US 2009/0064090 A1
(43) Pub. Date: Mar. 5, 2009

(54) MERGED VIEW OF APPLICATION CUSTOMIZATIONS

(75) Inventors: Steven P. Anonsen, Fargo, ND (US); Michael Tyrsted, Copenhagen (DK); Morten Nielsen, Skodsborg (DK); Christian M. Madsen, Frederiksberg (DK); Lars Hammer, Federiksberg (DK); Thomas Hejlsberg, Horsholm (DK); Peter Borring Sorensen, Federiksberg (DK)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/850,520

(22) Filed: Sep. 5, 2007

(51) Int. Cl. G06F 9/44

(52) U.S. Cl. 717/104

(57) ABSTRACT

The customization system receives an application model that contains one or more elements stored in a database. The customization system receives a modification to an element of the application model. The customization system stores the modification to the element separately from the application model such that the application model is accessible in either a modified or unmodified state. Thus, multiple third parties can make changes to the same application model elements and business logic without causing conflicts with each other. In addition, updates and patches to the enterprise resource planning system can be applied with less likelihood that the customizations will be negatively affected.

### BACKGROUND

Enterprise Resource Planning (ERP) refers to the field of integrating most of the data and processes of an organization into a unified system. A typical ERP system uses multiple components of computer software and hardware to achieve the integration. A key ingredient of most ERP systems is the use of a unified database to store data for the various system components. The introduction of an ERP system to replace two or more independent applications eliminates the need for external interfaces previously required between these applications, and it provides additional benefits that range from standardization and lower maintenance (one system instead of two or more) to easier reporting and greater reporting capabilities (as all data is typically kept in one database). ERP systems typically attempt to cover all basic functions of an organization, regardless of the organization's business or charter. For example, ERP systems may cover manufacturing, warehousing, logistics, Information Technology, accounting, human resources, marketing, payroll, and strategic management. Businesses, nonprofit organizations, nongovernmental organizations, governments, and other organizations utilize ERP systems.

To implement ERP systems, organizations often seek the help of an Independent Software Vendor (ISV), Value-Added Reseller (VAR), or third-party consulting company that typically provides three areas of professional services: consulting, customization and support. Consulting typically involves initial advice on how the ERP system will be used and areas to target for customization to suit the needs of the particular organization. Consulting may include additional product training; creation of process triggers and workflow; specialist advice to improve how the ERP is used in the business; system optimization; and assistance writing reports, complex data extracts or implementing business intelligence. Customization is the process of extending or changing how the system works by writing new user interfaces and underlying application code. Such customizations typically reflect the specific business needs of an organization that are not supported by the core routines of the ERP system software. Examples of such code include early adopter features (e.g., mobility interfaces) or interfaces to third-party applications. There are typically dozens of ancillary systems with which the core ERP software has to interact. Many third-party software plug-ins are available that are designed to interface with particular ERP software and provide common customizations. A particular organization may use dozens of third-party plug-ins to provide all of the desired functionality. Support involves ongoing product assistance after consulting and customization are complete.

Organizations that customize ERP systems want to have the customizations preserved throughout the life cycle of the ERP system, which may include patches and upgrades to the ERP software. One ERP system is Microsoft Dynamics AX. Today, customizers of the deployed Dynamics AX application can customize both the application models and the business logic. Customizations to the application models typically modify or replace items stored in a database, such as the fields on a form. Customizations to the business logic typically involve changes to source code provided by the ERP system. When the ERP system is being used, a runtime loads the appropriate application model items and executes the appropriate business logic to implement the ERP system.

Both kinds of changes can introduce conflicts that make it difficult to preserve customizations. For some application models, conflicts are likely because changes are not very granular. For example, a change to a form replaces the entire form, even if the change is only to modify the color of a control or add a field. In addition, all customizations of a particular application model item (e.g., a form) are made to the same file, causing every customization of the item to conflict with all other customizations of the item. For business logic, multiple customizations to the same source code will conflict, and those conflicts must be manually resolved when the product is deployed. Thus, although source code customizations provide significant flexibility, they have negative long-term effects, as most customers must reapply customizations when they upgrade or patch the product. These issues reduce upgrade revenue, because customers are reluctant to upgrade, plus they reduce system stability and degrade customer satisfaction.

### SUMMARY

A customization system is provided for avoiding conflicts when changes are made to the application model and business logic of an ERP system. The customization system receives an application model that contains forms stored in a database. The forms may have elements, such as fields, controls, images, and so forth. The customization system receives a modification to an element of the application model. The customization system stores the modification to the element separately from the application model such that the application model is accessible in either a modified or unmodified state. The customization system also allows changes to the business logic of the ERP system. However, rather than modifying the source code, third parties can provide customizations by registering for events that signal locations in the business logic where changes may be desired. Thus, multiple third parties can customize the same application model elements and business logic, and the customization system reduces the chances of a conflict. In addition, updates and patches to the ERP system can be applied with less likelihood that the customizations will be negatively affected.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates the components of the customization system in one embodiment.

FIG. 2 is a block diagram illustrating the hub-and-spoke approach to application model changes in one embodiment.

FIG. 3 is a block diagram that illustrates a set of classes for storing deltas of an application model in one embodiment.

FIG. 4 is a display diagram that illustrates the merged view containing the original application model integrated with one or more customizations in one embodiment.

FIG. 5 is a display diagram that illustrates the raw view that shows the customizations without existing model elements in one embodiment.

FIG. 6 is a block diagram that illustrates the façade layer in one embodiment.

### DETAILED DESCRIPTION

### Overview

A customization system is provided for avoiding conflicts when changes are made to the application model and business logic of an ERP system. The customization system receives an application model that contains one or more elements stored in a database, such as forms, reports, fields, controls, images, and so forth. For example, the application model may contain an order entry form that contains fields for entering a customer name, product type, price, and so on. The customization system receives a modification to an element of the application model. For example, a customer may want to add a field for storing a social security number that is not on the original order entry form of the application model. The customization system stores the modification to the element separately from the application model such that the application model is accessible in either a modified or unmodified state. The customization system also allows changes to the business logic of the ERP system. However, rather than modifying the source code, third parties can provide customizations by registering for events that signal locations in the business logic where changes may be desired. Thus, multiple third parties can customize the same application model elements and business logic, and the customization system reduces the chances of a conflict. In addition, updates and patches to the ERP system can be applied with less likelihood that the customizations will be negatively affected.

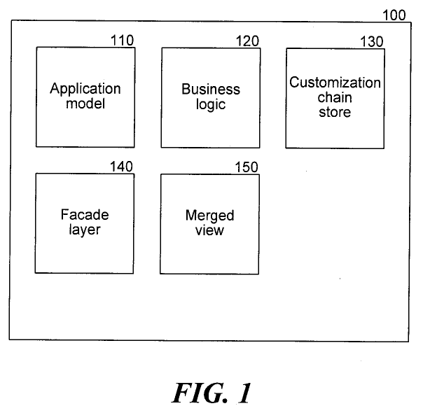

FIG. 1 illustrates the components of the customization system in one embodiment. The functionality of these components is described in further detail in the sections below. The customization system 100 contains an application model component 110, a business logic component 120, a customization chain store component 130, a façade layer 140, and a merged view component 150. The application model component 110 stores the initial version of the application model provided by the ERP system manufacturer and any updates or patches provided by the manufacturer. The business logic component 120 stores the business logic provided by the ERP system manufacturer. The customization chain store component 130 stores customizations created by a developer or third party that modifies the application model and/or business logic provided by the ERP system manufacturer. The façade layer 140 determines which customizations are active for a particular installation and presents a unified application model that starts with the initial application model provided by the ERP system manufacturer and applies any active customizations to produce the desired behavior at run time. In some embodiments, the façade layer is used at design time, and at runtime active customizations are simply merged in. An advantage of the façade layer is that it can also handle changes (e.g., edits) occurring after objects and customizations have been loaded. The merged view component 150 displays a view of the application model with selected customizations applied so that an application developer can browse the unified application model.

The computing device on which the system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

### Application Model Customizations

The customization system uses a hub-and-spoke approach to application model changes. Prior systems used a layered approach in which the ERP system provided an element, such as a form, and then third parties could replace the form. When the runtime loaded an application model item or element of an item, it took the element from the highest layer in which it appeared. Application items can include, for example, forms, reports, and scripts, while elements can include parts of these, such as an edit control on a form, a field on a report, and so forth. In contrast, the customization system uses a hub-and-spoke approach to customizing the application model. Two third parties can make changes to the same application element, and the runtime will merge their changes when the application is deployed or at run time. If merging is not possible, the customization system will indicate to the administrator that a conflict exists. For example, one developer can change the color of a control and another can change the typeface without conflict. This dramatically reduces the potential for conflicts between customizations as compared to the layered approach of replacing an entire form.

In some embodiments, the customization system allows customizations to be further customized. For example, one third party may add a new field to a form, and another third party may change the color of the new field. Thus, the customization system creates many possibilities for third-party products that extend the ERP system. For example, a third party may provide a basic customization package containing common customizations for operating a retail store, with add-on packages that further customize the basic package for more specific environments, such as a shoe store. In this way, the customization system supports chains of customizations.

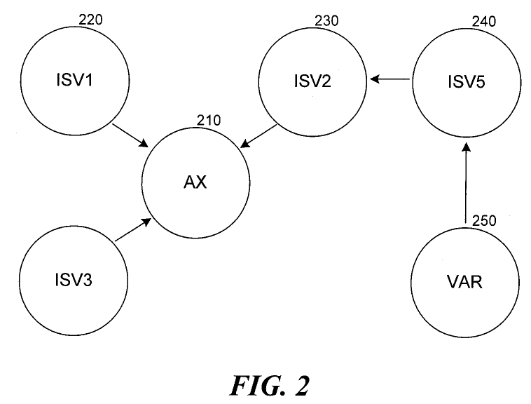

FIG. 2 is a block diagram illustrating the hub-and-spoke approach to application model changes in one embodiment. The AX node 210 represents the basic Dynamics AX ERP system. Each node pointing to it represents a set of customizations made to the basic system made by a particular customizer. For example, the ISV1 node 220 represents a set of customizations made by a first ISV, and the ISV2 node 230 represents a set of customizations made by a second ISV. Another ISV has further customized the customizations of the second ISV, as represented by the ISV5 node 240 pointing to the ISV2 node 230. In addition, a VAR has further customized the ISV5 customizations as indicated by the VAR node 250. As an example, if the base AX model 210 contains a form with two buttons Button1 and Button2, then the customizations of ISV2 230 may add a new button Button3. The customizations of ISV5 240 may add an additional button Button4, and may also modify Button1 (e.g., by changing its caption), creating Button1delta. When the merged view is presented to a user, the user may choose to view the base AX model 210 view and will only see Button1 and Button2. If the user chooses to view the node ISV2 230, then the user will see Button1, Button2, and Button3. If the user chooses to view the node ISV5 240, then the user will see Button1delta, Button2, Button3, and Button4, because the customizations of ISV5 240 include the base AX model 210 and the customizations of ISV2 230.

In some embodiments, the customization system stores changes to the application model as a delta to a portion of a model (e.g., a set of changes to some application element). For example, a delta may identify an existing element that is being customized, the type of change, and a new value for the changed property of the element. As another example, the delta may identify a new element that is being added, including the type of the element and the properties of the new element. One type of delta is a change to metadata describing a property. For example, a developer may change the string length of a property. A developer may also add new metadata, such as inserting a property into a property group that is then shown on forms. These modifications are stored separately as deltas, which are then applied, at run time, to the original application's metadata.

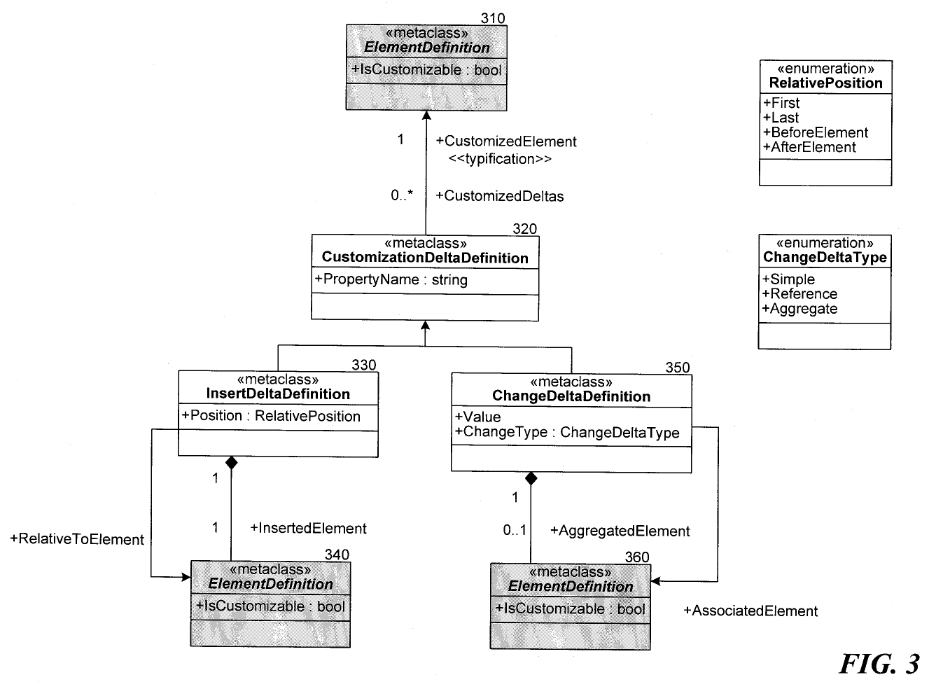

FIG. 3 is a block diagram that illustrates a set of classes for storing deltas of an application model in one embodiment. The application model contains many elements, such as element 310. The element 310 has a Boolean property IsCustomizable that is set to true if a developer can customize the element. The CustomizationDeltaDefinition class 320 identifies a particular customization or delta, and it points to the element 310 that is modified by the customization. It is possible that many customizations will modify the same element. The InsertDeltaDefinition class 330 describes a delta that adds a new element to the application model. The new element is placed into the model with a position relative to an existing element 340 of the model. The class contains information identifying the relative position of the new element and the element to which the position relates. The ChangeDeltaDefinition class 350 describes a delta that modifies an existing element. For example, the delta may aggregate the element with another element. In this case, the class 350 references the aggregated element 360.

In some embodiments, the customization system receives an indication of whether a particular modification should be active. For example, a customer that installs plug-ins from several third parties may enable and disable various modifications made by the plug-ins by setting them as active or inactive. If the customer likes the order entry form from one third party, then the customer can set the modifications to the order entry form from that third party as active.

In some embodiments, the customization system prevents customizations that delete or rename an element to preserve the ability for further customizations. For example, if one third party can delete a model element, that may prevent another third party from modifying the element. This could cause problems such as the third party recreating the element as a new element that has no association with the original element. Thus, the customization system may prevent elements from being deleted or renamed so that third parties can be assured that elements provided by the base ERP system are always available for customization. If a third party wants to remove the element, the customization system may allow the third party to mark the element as inactive rather than deleting the element.

In some embodiments, the customization system provides an application for viewing the application model. A developer making changes will typically want to see the aggregate of the application element and all of the customizations made to it. Seeing just the list of deltas makes it hard to visualize the end result of those changes. The customization system provides a merged customization view that shows any given application element with the set of deltas to that element applied. The viewing application may be configurable to determine which customizations are shown. For example, the viewing application may be configured to show the original application model, only customizations from a particular third party, or all customizations from all third parties. For example, if a form provided by the original application model has been modified by a third party to add a new field “MyField,” then the viewing application may display the form in a merged view containing all of the original fields listed together with the new field. The merged view of customized elements is a view where the combined metadata of an application element and all or part of a chain of deltas targeting that element are merged into one view similar to how the deltas will be applied at run time.

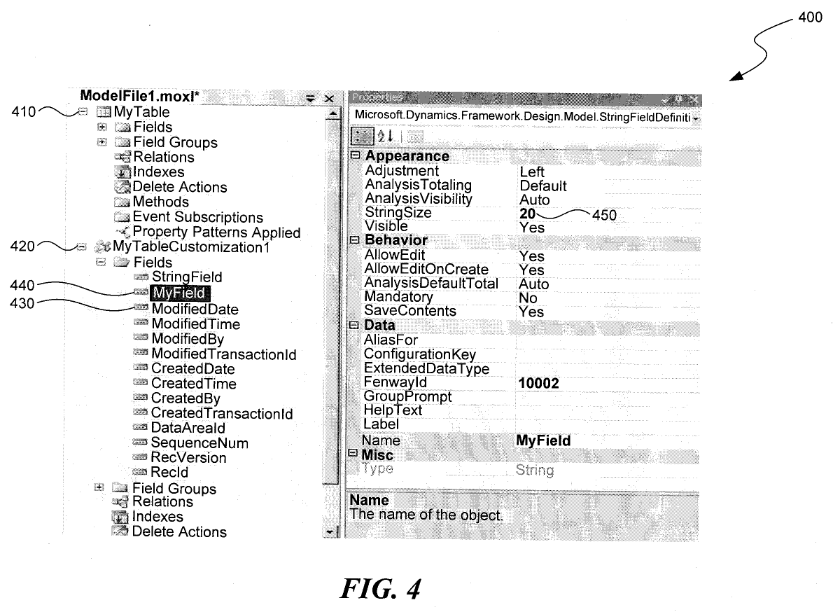

FIG. 4 is a display diagram that illustrates the merged view containing the original application model integrated with one or more customizations in one embodiment. The application model displayed in the merged view 400 contains a table 410 and a customization to the table 420. The customized table 420 contains a list of fields. Some fields, such as the ModifiedDate field 430, are part of the application model provided by the manufacturer of the ERP system. Other fields, such as the MyField field 440, have been added as customizations by a developer. Alternatively, the MyField field 440 may have been part of the original application model, but properties of the field, such as the StringSize property 450, may have been changed by the developer. The merged view presents a unified view of customizations to the user so that the user can see the application model with all customizations that would be applied at run time.

In some embodiments, the customization system receives changes to the application model within the merged view and automatically captures these changes as deltas to the application model. For example, a user viewing a form in the viewing application may change the length of a field without knowing whether that field was provided by the base ERP system or by a customization plug-in from a third party. The customization system creates a delta identifying the appropriate model element and captures the user's changes to the field.

In some embodiments, the customization system provides a raw view in the viewing application for displaying particular customizations. For example, a customer may want to see what changes have been made to a form or other part of the application model by a particular third-party plug-in. The raw view allows the customer to see the changes by themselves or as deltas. For example, the raw view can be helpful for diagnosing problems or determining which customization packages are actively being used.

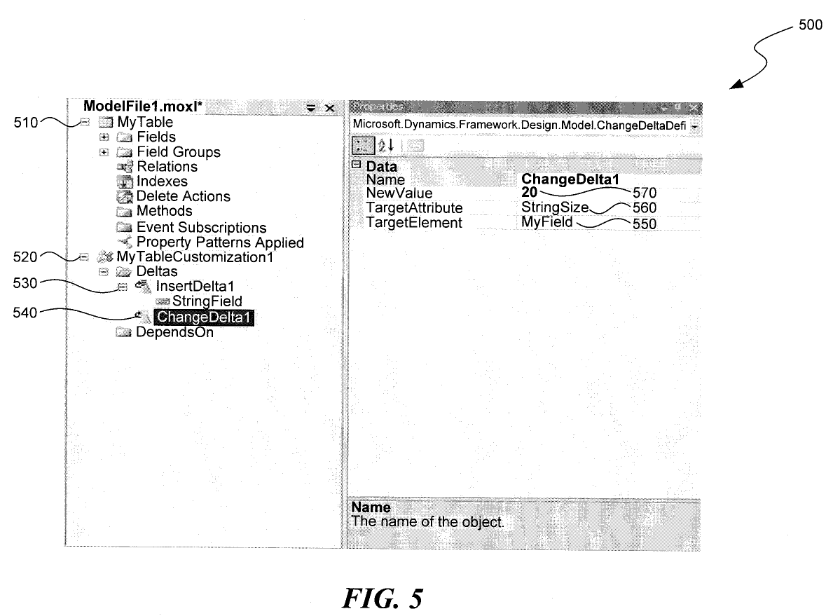

FIG. 5 is a display diagram that illustrates the raw view that shows the customizations without existing model elements in one embodiment. Like the application model in FIG. 4, the application model displayed in the raw view 500 contains a table 510 and a customization to the table 520. In the raw view, the customized table 520 shows only the deltas to the original table. The customized table 520 contains an insert delta 530 that adds a new field “MyField” to the application model. The customized table 520 also contains a change delta 540 that modifies the insert delta 530. The change delta 540 identifies a target element 550 that it modifies, a target attribute 560 of the target element 550, and a new value 570 for the target attribute 560. Using the raw view 500, a developer can see the effect of each of a chain of deltas individually, which may help the developer to identify problems or to make additional changes at an appropriate point in the chain.

In some embodiments, the customization system provides a layer that hides the details of customizations from a higher-level application, such as an editor. For example, the customization system may provide an in-memory model, called a façade, that takes into account changes to the application model and presents a merged view (e.g., a unified application model) of the changes to an editing application. This allows editors and other applications previously written to interoperate with a particular ERP system to continue to work with that system after customizations have been made, without needing to be modified based on the customizations. For example, the viewing application described above may use the façade to produce the merged view.

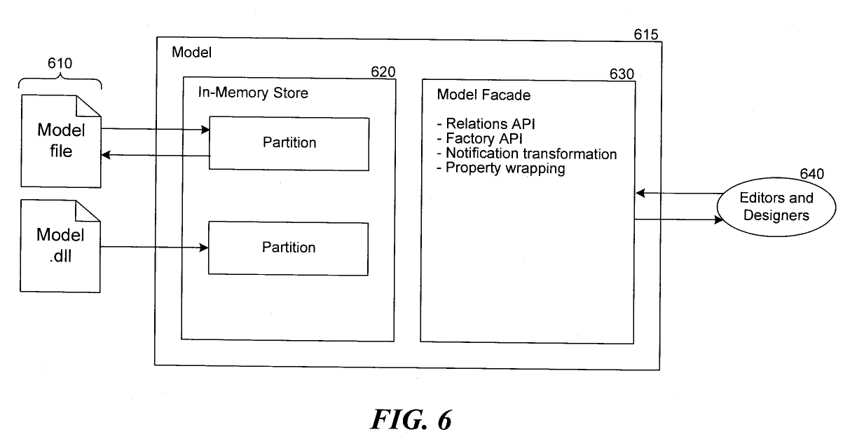

FIG. 6 is a block diagram that illustrates the façade layer in one embodiment. An application model 615 is persisted in stored files 610 that describe the application model 615. The stored files 610 may include the original application model provided by the ERP system manufacturer and customizations added by customizers. The application model 615 is loaded into an in-memory store 620. A façade layer 630 interfaces between the in-memory store 620 and applications 640 that use the application model, such as editors and designers. The façade layer 630 makes it appear to the applications that the original application model and any customizations are merged into one—in other words, that the extensions provided by the additional file(s) have been applied to the original application model. The façade layer 630 provides a layer of abstraction including a relations API for querying about relationships, a factory API for creating new elements, a notification transformation component to notify editors when changes take place, and a property wrapping component.

The implementation of the relations API will ensure that every time an editor asks for a set of elements from the application model, it gets back the combined list from the original and the customizations. For example, when the relations API receives a query from an application to list the fields of a particular form, the relations API queries the base model to generate an initial list of fields, and then steps through any active customizations to determine whether fields were added or modified by the customization. Next, the relations API responds to the application query with a list of information that includes the applied customizations. Thus, the application sees only a continuous model and does not know that the model was composed of a base model with applied customizations.

The factory API ensures that when a new element is created by an editor, a customization is created rather than an original element. For example, in the past an editor might simply copy and replace a file containing an application item such as a form with a new customized form. However, with the customization system, applications are expected not to modify the base model but rather to submit deltas that describe modifications to the base model or to other customizations. By controlling the layer through which applications create new elements, the customization system ensures that the base model is not modified and a delta is correctly created to describe the new element.

The application model notifies editors when changes have taken place. For example, if a new element is added, then the application model may send a notification that a new element has been added. The notification transformation component intercepts these notifications and passes modified notifications to the editors. This has the effect that any editor containing a customization of the element being customized will be updated. These modified notifications make it appear to the editors that a given change happened in the combined model. For example, if the notification transformation component receives a notification that a new delta was added to the model that changes the length of a field, then the notification transformation finds the original field and sends a notification to applications or editors that the length of the original field has changed. In this way, the applications do not need to understand deltas or how data is stored by the customization system.

If the editors make use of a property sheet—as in Visual Studio—or other method of viewing and modifying object attributes, the property wrapping component wraps the classes that appear in that property sheet before they are passed to the editor. The wrapper classes ensure that the property values shown and any lists of referenced elements that appear in any lookup reflect the combined model. Thus, rather than seeing just the properties of an element defined by the base model, an editor can see properties added or modified by customizations applied to the base model.

Thus, the façade layer ensures that editors can be created without knowing whether merged view behavior is desired or not. As long as the editor uses the set of APIs provided by the façade layer, then the merged view behavior can be turned on and off as desired. In addition, existing tools can view the model with any particular set of customizations applied, because the façade layer handles the details of creating the merged view of the application model.

In some embodiments, the relations API of the customization system contains standard and merged versions of each API. The standard API methods retrieve information for related objects based on a base version of the application model. The merged API methods retrieve information that includes any applicable model customizations for related objects.

### Conclusion

From the foregoing, it will be appreciated that specific embodiments of the customization system have been described herein for purposes of illustration, but that various modifications may be made without deviating from the spirit and scope of the invention. For example, although ERP applications have been described, the customization system can be applied to other environments where conflicting changes to an application model or business logic commonly occur. Accordingly, the invention is not limited except as by the appended claims.

I/We claim:

1. A method of modifying an application model of an enterprise resource planning application, the method comprising:
receiving an application model, wherein the application model comprises one or more elements stored in a database;
receiving a modification to an element of the application model; and
storing the modification to the element separately from the application model such that the application model is accessible in either a modified or unmodified state, wherein the modification identifies the modified element.

2. The method of claim 1 including receiving an update from a manufacturer of the application model that modifies the application model and retains the separately stored modification.

3. The method of claim 1 wherein the element is selected from the group consisting of a form, a report, a script, a table, a query, and a menu item.

4. The method of claim 1 wherein the modification adds a new field to the element.

5. The method of claim 1 wherein the modification changes a property of the element.

6. The method of claim 1 including receiving an indication of whether the modification is active.

7. The method of claim 1 including determining the type of the received modification, and when the determined type is a rename or delete of the element, preventing the modification to the element.

8. The method of claim 1 including applying the application model at run time of the application.

9. The method of claim 1 including receiving business logic describing the behavior of the element of the application model.

10. The method of claim 9 wherein the modification is received through a façade layer.

11. A computer-readable medium encoded with instructions for controlling a computer system to display a merged view of customizations to an enterprise resource planning system, by a method comprising:
receiving an application model comprising an initial version of an element of the application model;
receiving a customized version of the element of the application model; and
visually merging the application model with the customized version of the element such that the customized version of the element is displayed in place of the initial version of the element in a merged view with other unmodified elements of the application model.

12. The computer-readable medium of claim 11 wherein a user can switch between the merged view and a raw view that displays only the customized version of the element.

13. The computer-readable medium of claim 11 including storing the customized version of the element as a delta associated with the initial version of the element.

14. The computer-readable medium of claim 11 including, while displaying the merged view, receiving a new customization to the application model and automatically creating a delta describing the new customization based on an element of the application model modified by the customization.

15. The computer-readable medium of claim 11 wherein visually merging the application model comprises invoking an in-memory façade layer that presents the application with any customizations as a unified application model.

16. The computer-readable medium of claim 11 wherein the customized version of the element is part of a chain of customizations to the application model.

17. A system for displaying a merged view of changes to a base version of an enterprise resource planning application, the system comprising:
an application model component configured to store an application model that describes elements of the enterprise resource planning application;
a customization chain store component configured to store one or more customizations provided by a third-party developer that modify the application model by adding or modifying the elements of the enterprise resource planning application; and
a merged view component configured to merge information from the application model and the customizations to display a unified view that shows customizations integrated with the elements of the application model.

18. The system of claim 17 including a business logic component configured to store business logic that describes the behavior of the elements of the application model.

19. The system of claim 17 including a façade layer component that provides an API for presenting a merged view of the application model and customizations to the merged view component.

20. The system of claim 19 wherein the façade layer receives requests to add new application elements.
